(19) United States
(12) Patent Application Publication
(10) Pub. No.: US 2006/0066565 A1
(43) Pub. Date: Mar. 30, 2006

(54) Controller apparatus

(76) Inventors: Kevin Manley, Daytona Beach, FL (US); Omar Haddad, Daytona Beach, FL (US)

Correspondence Address: King & Jovanovic, PLC, 170 College Avenue, SUITE 230, HOLLAND, MI, 49423, US

(21) Appl. No.: 10/952,467

(22) Filed: Sep. 28, 2004

(51) Int. Cl. G09G 5/00

(52) U.S. Cl. 345/156

(57) ABSTRACT

A controller comprising a housing, at least one user input device and an output assembly. The housing includes an upper surface, a lower surface, opposing side surfaces and a front surface. The at least one user input device comprises a 3D roller assembly. The 3D roller assembly comprises a x-axis roller, a y-axis roller and a z-axis roller. Each of the x-axis roller, the y-axis roller and the z-axis roller rotate about respective axes which are substantially orthogonal to each other. The output assembly capable of coupling the at least one user input device to an outside hardware device.

### BACKGROUND OF THE INVENTION

1. Field of the Invention

The present invention relates in general to an input device for a computer and the like, and more particularly, to a controller apparatus for use in association with a computer or other hardware device, as, for example a controller for gaming software. The invention is not limited to use in association with game software.

2. Background Art

The use of controllers, for example, in association with gaming software has greatly advanced through recent decades. Initially, the game controller comprised a single button and one of a single roller or joystick. Such controllers were utilized with early “pong” games and early video game systems (i.e., Intellevision, Atari 2600, Coleco-Vision).

As gaming systems and software advanced, controllers have advanced so as to include a multitude of buttons and input devices (i.e., xbox controllers, Nintendo controllers, Sony Playstation controllers). For certain software programs, specialized controllers mimicking real devices are utilized (i.e., specialized controllers used with automobile or aircraft simulators). While the devices have advanced, there remain certain drawbacks to current controllers.

For example, current controllers do not have intuitive controllers for controlling rotation in three axis simultaneously. Moreover, current controllers lack a high inertia wheel which can spin for extended periods of time at relatively high velocity. Such controllers enhance game play and allow software developers to increase the complexity of certain software.

Accordingly, it is an object of the invention to provide a 3D controller which can control rotation simultaneously along three axis.

It is another object of the invention to provide a spinner wheel which has a high moment of inertia so as to permit extended rotation at a relatively high velocity.

It is another object of the invention to provide conventional controllers in cooperation with either a 3D rotational controller or a spinner wheel or both.

These and other objects of the invention will become apparent in light of the specification and claims appended hereto.

### SUMMARY OF THE INVENTION

The invention comprises a controller. The controller comprises a housing, at least one user input device and an output assembly. The housing includes an upper surface, a lower surface, opposing side surfaces and a front surface. The at least one user input device comprises a 3D roller assembly. The 3D roller assembly comprises a x-axis roller, a y-axis roller and a z-axis roller. Each of the x-axis roller, the y-axis roller and the z-axis roller rotate about respective axes which are substantially orthogonal to each other. The output assembly capable of coupling the at least one user input device to an outside hardware device.

In a preferred embodiment, each of the x-axis roller, the y-axis roller and the z-axis roller is coupled to a mechanical encoder.

In another preferred embodiment, the x-axis roller is positioned along an edge of the upper surface and an edge of one opposing side surface, the y-axis roller is positioned on the upper surface of the housing, and the z-axis roller is positioned along an edge of one opposing side surface and along an edge of the front surface.

In yet another preferred embodiment, the x-axis roller is positioned along an edge of the upper surface and an edge of one opposing side surface, the y-axis roller is positioned along an edge of the upper surface and an edge of the front, the z-axis roller is positioned along an edge of one opposing side surface and an edge of the front surface, wherein each axis substantially corresponds to the respective edge.

In another preferred embodiment, the x-axis roller is positioned on the upper surface, the y-axis roller is positioned on the front surface and the z-axis controller is positioned on one side surface, wherein each roller is configured to rotate about a respective axis that is perpendicular to the surface upon which the respective roller is positioned.

Preferably, the x-axis roller, the y-axis roller and the z-axis roller are positioned in proximate to each other so as to permit simultaneous usage of same by a single hand of a user.

In one such embodiment, the x-axis roller, the y-axis roller and the z-axis roller are positioned proximate to each other so as to permit simultaneous usage of same by three fingers of a user.

In a preferred embodiment, the at least one input device further comprises at least one of the group consisting of: buttons, two position switches, three position switches and joystick.

In another preferred embodiment, the at least one input device further comprises a 3D pad associated with the housing.

In one such preferred embodiment, the 3D pad comprises an x-y controller positioned on the upper surface of the housing and a z controller positioned on the second side surface.

In another preferred embodiment, the z controller comprises a first upper button and a second lower button.

In another preferred embodiment, the at least one input device further comprises a spinner wheel associated with the housing. The spinner wheel comprises a body having a relatively high moment of inertia and means for measuring both the direction of rotation and the velocity of rotation of thereof.

In one such embodiment, the body of the spinner wheel further includes a plurality of equally spaced openings along the outer perimeter thereof. The measuring means comprises at least one light emitter positioned on one side of the spinner wheel and a dual light detector positioned on the opposing side of the spinner wheel.

In another aspect of the invention, the invention comprises a controller. The controller includes a housing, at least one user input device and an output assembly. The housing includes an upper surface, a lower surface, opposing side surfaces and a front surface. The user input device comprises a spinner wheel having a relatively high moment of inertia. The output assembly is capable of coupling the at least one user input device to an outside hardware device.

In one embodiment, the spinner wheel further comprises means for measuring both the direction of rotation and the velocity of rotation of thereof.

In another preferred embodiment, the body of the spinner wheel further includes a plurality of equally spaced openings along the outer perimeter thereof. The measuring means comprises at least one light emitter positioned on one side of the spinner wheel and a dual light detector positioned on the opposing side of the spinner wheel.

In yet another preferred embodiment, the at least one input device further comprises at least one of the group consisting of: buttons, two position switches, three position switches and joystick.

In another preferred embodiment, the at least one input device further comprises a 3D pad associated with the housing.

In one such embodiment, the 3D pad comprises an x-y controller positioned on the upper surface of the housing and a z controller positioned on the second side surface.

In another such embodiment, the z controller comprises a first upper button and a second lower button.

In another preferred embodiment, the spinner wheel is capable of rotating through at least 3 revolutions prior to stopping.

In another preferred embodiment, the spinner wheel is capable of rotating through at least 6 revolutions prior to stopping.

### BRIEF DESCRIPTION OF THE DRAWINGS

The invention will now be described with reference to the drawings wherein:

FIG. 1 of the drawings comprises a top, back, left side perspective view of the controller of the present invention;

FIG. 2 of the drawings comprises a top, back, right side perspective view of the controller of the present invention;

FIG. 3 of the drawings comprises a back, left side perspective view of the controller of the present invention;

FIG. 4 of the drawings comprises a cutaway perspective view of the controller of the present invention showing, in particular, the 3D rollers, and mechanical encoders associated therewith;

FIG. 5 of the drawings comprises a schematic view of a mechanical encoder associated with the 3D rollers of the controller of the present invention;

FIG. 6 of the drawings comprises a graphical representation of the two outputs from the mechanical encoders associated with the 3D rollers of the controller of the present invention;

FIGS. 7a-7c comprise various different embodiments of the 3D rollers of the controller of the present invention;

FIG. 8 of the drawings comprises a perspective view of the spinner wheel of the controller of the present invention;

FIG. 9 of the drawings comprises a cross-sectional view of the spinner wheel of the controller of the present invention;

FIG. 10 of the drawings comprises a schematic view of the sensor associated with the spinner wheel of the controller of the present invention; and

FIG. 11 of the drawings comprises a graphical representation of the two outputs from the dual light detector of the sensor associated with the spinner wheel of the controller of the present invention.

### DETAILED DESCRIPTION OF THE INVENTION

While this invention is susceptible of embodiment in many different forms, there is shown, in the drawings, several specific embodiments with the understanding that the present disclosure is to be considered as an exemplification of the principles of the invention and is not intended to limit the invention to the embodiments illustrated.

It will be understood that like or analogous elements and/or components, referred to herein, are identified throughout the drawings by like reference characters. In addition, it will be understood that the drawings are merely representations of the present invention, and some of the components may have been distorted from actual scale for purposes of pictorial clarity.

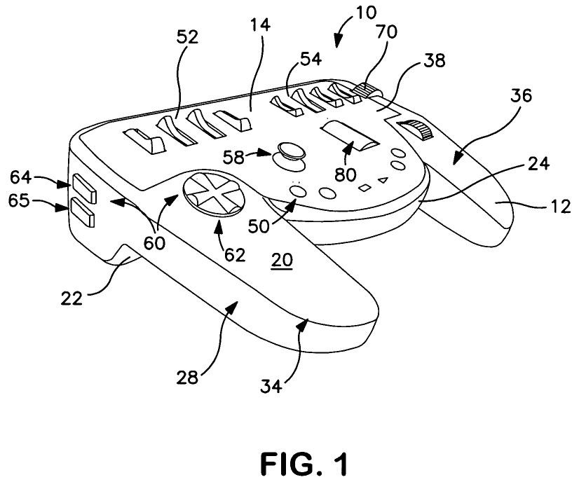

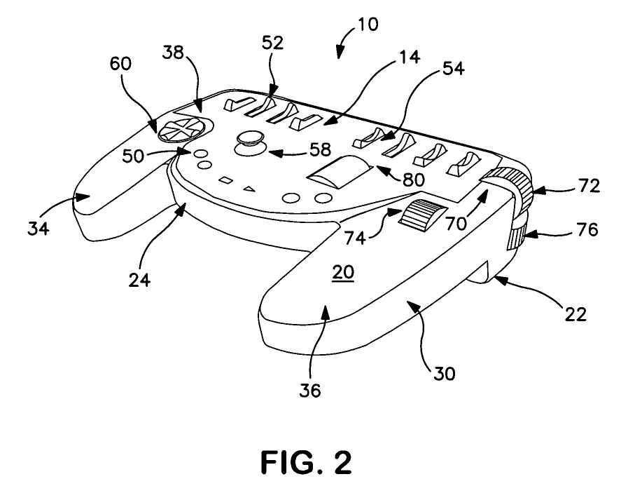

Referring now to the Figures, and in particular to FIGS. 1 and 2, the controller of the present invention is shown generally at 10. The controller is suitable for use in association with gaming software which is operated on any number of different hardware, including, but not limited to computers, game consoles (xbox, PS2, Nintendo, among others), and other dedicated gaming products. Of course, the controller is not limited for use in association with gaming software, and, it is contemplated that the controller may be utilized with other genre of software (drafting software, modeling software, etc.).

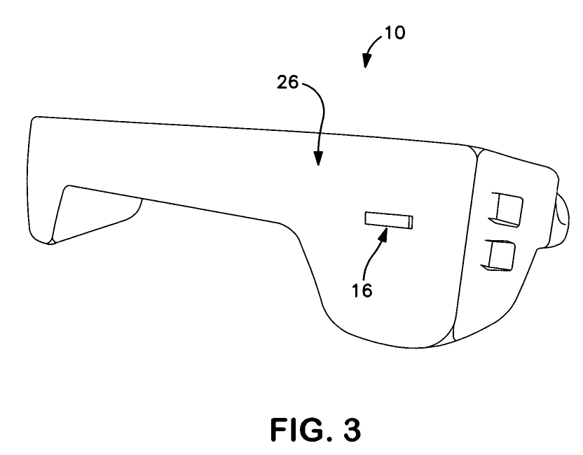

Controller 10 is shown in FIGS. 1 and 2 as including housing 12, a plurality input assemblies 14 and an output assembly 16 (FIG. 3) capable of electronically coupling the plurality of input assemblies to outside hardware. Housing 12 is shown as comprising upper surface 20 and lower surface 22. The upper surface is substantially planar, but is not limited to such a configuration. The upper surface includes an overlay region 38 configured to receive any number of custom overlays which may be configured for use with the controller. The upper and lower surfaces are separated from each other a predetermined distance by sides. The sides include first side surface 28 (FIG. 1) and second side surface 30 (FIG. 2), back surface 24 and front surface 26 (FIG. 3). At an upper end, the sides terminate proximate the top surface. At a lower end, the sides terminate proximate the bottom surface. The housing can be formed from a polymer through a casting or molding process, which will be understood by those of skill in the art.

Portions of the sides and the upper and lower surfaces form first handle region 34 and second handle region 36 which is positioned so as to oppose first handle region 34. In the embodiment shown, the housing is substantially symmetrical about a longitudinal axis extending between the first and second handle regions.

The plurality of user input devices include a number of conventional input devices in addition to input devices which are not conventional. For example, among other conventional input devices, the plurality of user input devices includes buttons, such as buttons 50, two position switches, such as two position switches 52 (both momentary and non-momentary), three position switches, such as three position switches 54 (both momentary and non-momentary), a joystick 58. In addition, the plurality of user input devices include three dimensional (3D) pad 60, 3D roller 70 and spinner wheel 80. Each of the plurality of input devices are coupled to output 16 which is capable of transmitting the signals acquired from each of the input devices to the hardware device with which the controller is associated.

In the embodiment shown, the buttons 50 are positioned along the bottom edge of the upper surface between the handle regions. Furthermore the two and three position switches 52, 54, respectively, are positioned along the upper edge of the upper surface. The joystick is centrally located on the upper surface of the game controller. Again, the particular position of the various conventional switches and the particular switches utilized can be varied by of ordinary skill in the art.

3D pad 60 is shown in FIG. 1 as comprising x-y coordinating button 62 and z direction buttons 64, 65. The x-y coordinating button 62 is positioned on upper surface 20 of housing 12. The x-y coordinating button is shown as a single surface, the corresponding electronics provide for a plurality of different inputs. Such inputs are achieved by pressing the button along the outer edge thereof at different locations. In the embodiment shown, the separate locations comprise at least N, S, E, W, NE, SE, NW, SW. In certain embodiments, this may be achieved by multiple surfaces, instead of the single surface shown in the present embodiment. The z direction buttons 64, 65 are positioned along first side surface 28. The relative position of the x-y coordinating button and the z direction buttons is such that they are usable in unison by the same hand of the user.

3D controller 70 is shown in FIG. 2 as comprising x-axis roller 72, y-axis roller 74 and z-axis roller 76. The x-axis roller is positioned at the interface between upper surface 20 and second side surface 30. The y-axis roller 74 is positioned on upper surface 20 proximate the x-axis roller. The z-axis roller 76 is positioned on the interface between second side surface 30 and front surface 26. Each of the roller surfaces include a series of surface undulations which enhance tactile feel. The rollers are each configured such that the axis of rotation of each are substantially orthogonal to each other. The rollers are spaced such that they can be controlled by a single hand of the user, in this embodiment, the right hand of the user. For example, the x-axis roller can be controlled by the index finger of the user, the y-axis roller can be controlled by the thumb of the user and the z-axis roller can be controlled by the middle finger of the user.

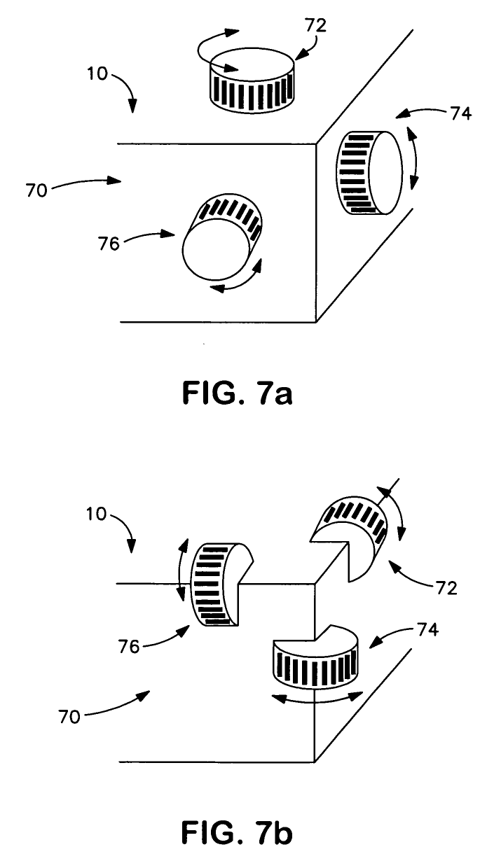

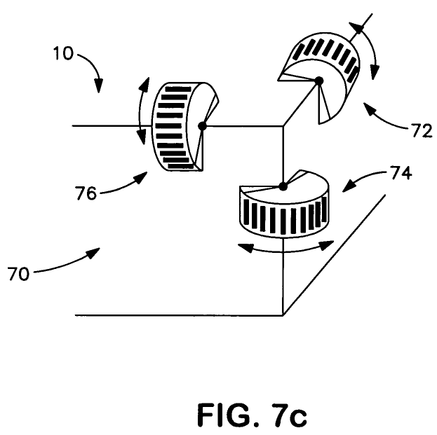

It is contemplated that the three rollers 72, 74 and 76 can be positioned in another orientation depending on the configuration of the housing. One such embodiment is shown in FIG. 7a wherein each of the rollers is positioned along one of the front surface, the side surface and the upper surface, rotates about an axis which is substantially perpendicular to the respective surface upon which it is positioned. In another embodiment, shown in FIG. 3, the rollers can be positioned along the interface between the front surface, the upper surface and the side surface. Advantageously, in any such embodiment, single handed operation is facilitated.

In another configuration, shown in FIG. 7c, the rollers comprise partial rollers which can rotate about respective axes of rotation 72a, 74a and 76a. The rollers are biased in a central position. As the rollers are rotated away from the central position rotation is imparted in the desired direction. When released, the roller returns to a central position. In such a position, the rollers do not rotate through a full circle, but through an arcuate distance in either direction of a central position. Of course, these type of rollers can be used in place of, or in conjunction with the rollers described herein.

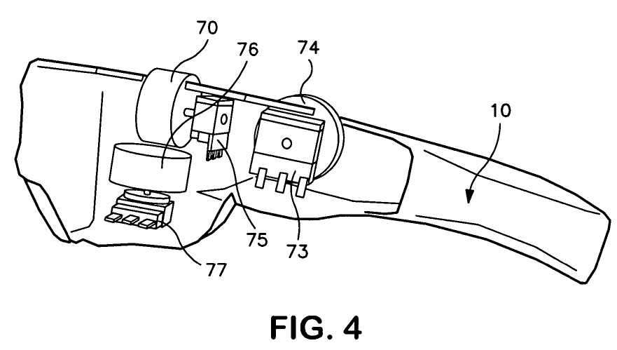

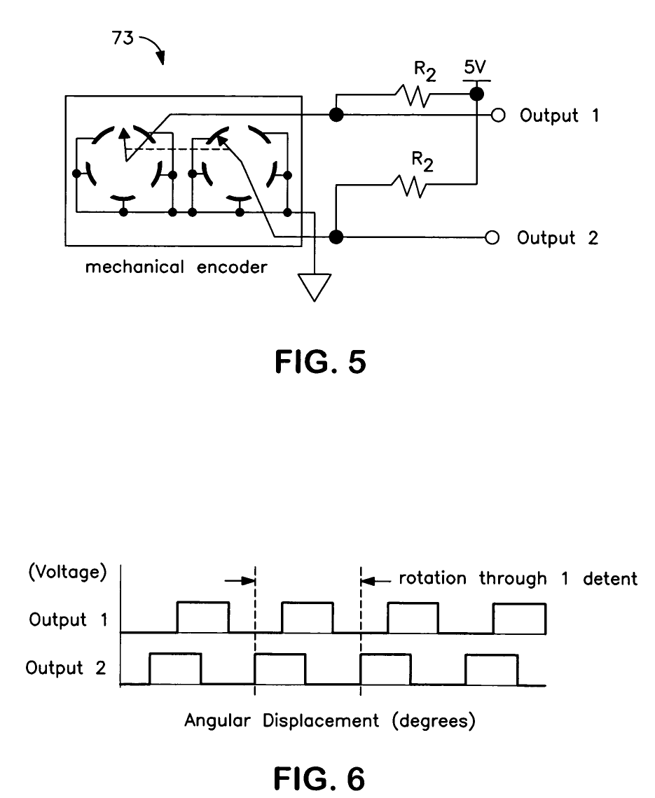

Referring now to FIG. 4, each of the rollers 72, 74, 76 are coupled to respective mechanical encoders 73, 75 and 77, respectively. In as much as each of the mechanical encoders are substantially identical, mechanical encoder 73 will be described with the understanding that each controller is substantially identical. A schematic of mechanical encoder 73 is shown in FIG. 5. As will be understood, as roller 74 is rotated, a square wave is generated to each of output 1 and output 2. Inasmuch as the encoder contacts are positioned 90° out of phase, rotation generates two square waves which are 90° out of phase. An example of the relative output is shown in FIG. 6. In such a manner, the direction of rotation can be determined through the use of two outputs which are phase shifted. Of course, other types of controllers are contemplated for use.

Spinner wheel 80 is shown in FIG. 1 as being positioned upon upper surface 20. The spinner wheel is of low friction and includes a substantially high moment of inertia. As such, when spun, is capable of spinning through a number of revolutions before the opposing forces (i.e., drag, friction, etc.) bring the spinner wheel to stop. The intertia of the spinner wheel and the resistance to rotation of same is such that a user can easily impart an impulse to the spinner wheel to achieve rotation thereof through at least about 3 and more preferably through at least about 6 rotations prior to stopping. In certain embodiments, the spinner wheel may continue to rotate through 15, 20 or more revolutions prior to stopping.

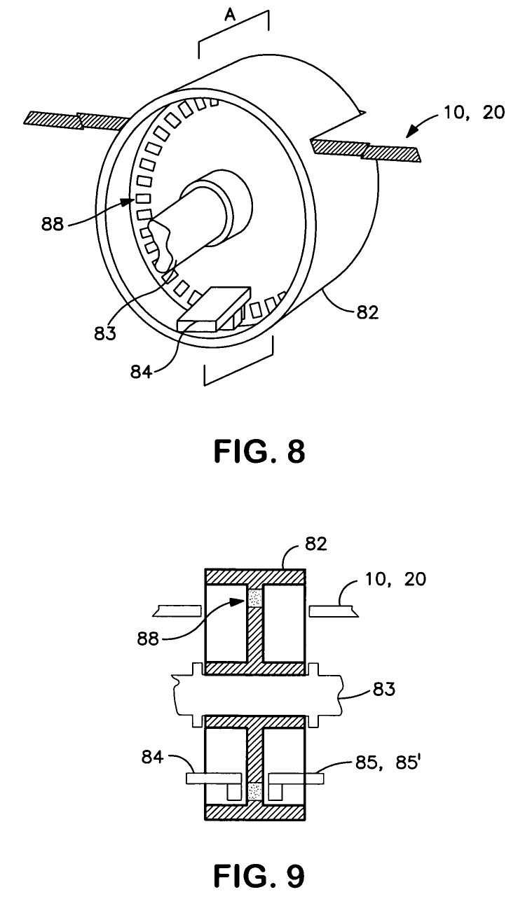

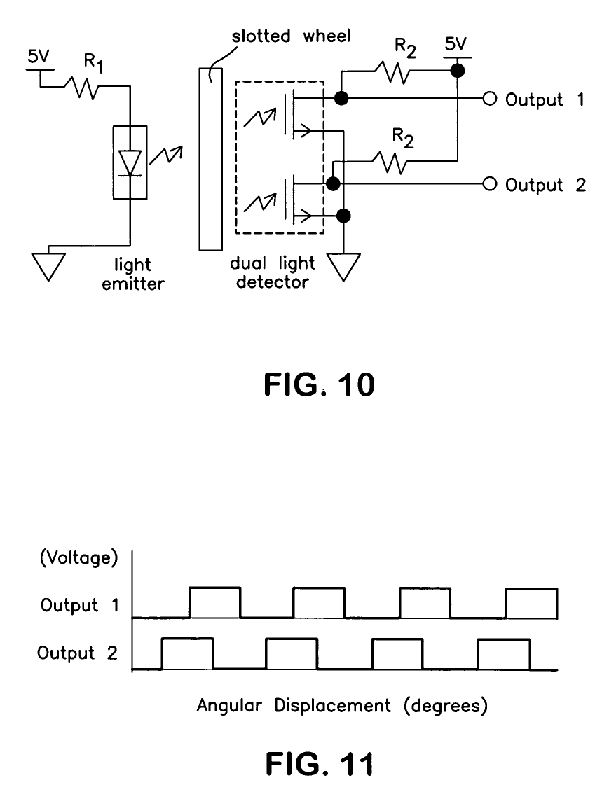

Referring now to FIGS. 8 and 9, the spinner wheel is shown as comprising body 82, rotation shaft 83, light emitter 84 and light detectors 85, 85′. Body 82 includes a plurality of opening 88 which are spaced apart a predetermined arcuate distance about the entire outer perimeter of the body. The openings are positioned so as to correspond with light emitter 84 and light detectors 85, 85′. A schematic representation of the light emitter and dual light detector are shown in FIG. 10. It will be understood that as the spinner wheel is rotated, and the light emitter is energized, the openings 88, selectively allow and preclude the detection of light by the dual light detectors. Inasmuch as the lights are positioned a linear distance apart from each other, the resulting detection of each output is staggered or, phase shifted. A sample output for each of the light detectors is shown in FIG. 11. The amount of shift or stagger between output 1 and output 2 and the length of each square wave provides a means for determining both the speed of rotation and the direction of rotation. The faster the rotation, the shorter the square wave, whereas the slower the rotation, the longer the square wave.

Output 16 is shown in FIG. 3 as comprising a USB connector which is capable of being associated with the game controller circuitry at its first end, and being coupled to a USB port on the hardware at the second end. In other embodiments output 16 may comprise a RF communication subassembly, or a system communicating under various protocols, such as, for example, Bluetooth, WiFi, etc. Of course, any number of different manners in which to communicate the signals directed from the various user input devices to the hardware device are contemplated for use, and the invention is not limited to use in association with any one particular output.

The foregoing description merely explains and illustrates the invention and the invention is not limited thereto except insofar as the appended claims are so limited, as those skilled in the art who have the disclosure before them will be able to make modifications without departing the scope of the invention.

What is claimed is:

1. A controller comprising:
a housing having an upper surface, a lower surface, opposing side surfaces and a front surface;
at least one user input device, the at least one user input device comprising a 3D roller assembly, the 3D roller assembly comprising:
a x-axis roller;
a y-axis roller; and
a z-axis roller, wherein each of the x-axis roller, the y-axis roller and the z-axis roller rotate about respective axes which are substantially orthogonal to each other; and
an output assembly capable of coupling the at least one user input device to an outside hardware device.

2. The controller of claim 1 wherein each of the x-axis roller, the y-axis roller and the z-axis roller is coupled to a mechanical encoder.

3. The controller of claim 1 wherein the x-axis roller is positioned along an edge of the upper surface and an edge of one opposing side surface, the y-axis roller is positioned on the upper surface of the housing, and the z-axis roller is positioned along an edge of one opposing side surface and along an edge of the front surface.

4. The controller of claim 1 wherein the x-axis roller is positioned along an edge of the upper surface and an edge of one opposing side surface, the y-axis roller is positioned along an edge of the upper surface and an edge of the front, the z-axis roller is positioned along an edge of one opposing side surface and an edge of the front surface, wherein each axis substantially corresponds to the respective edge.

5. The controller of claim 1 wherein the x-axis roller is positioned on the upper surface, the y-axis roller is positioned on the front surface and the z-axis controller is positioned on one side surface, wherein each roller is configured to rotate about a respective axis that is perpendicular to the surface upon which the respective roller is positioned.

6. The controller of claim 1 wherein the x-axis roller, the y-axis roller and the z-axis roller are positioned in proximate to each other so as to permit simultaneous usage of same by a single hand of a user.

7. The controller of claim 6 wherein the x-axis roller, the y-axis roller and the z-axis roller are positioned proximate to each other so as to permit simultaneous usage of same by three fingers of a user.

8. The controller of claim 1 wherein the at least one input device further comprises at least one of the group consisting of: buttons, two position switches, three position switches and joystick.

9. The controller of claim 1 wherein the at least one input device further comprises a 3D pad associated with the housing.

10. The controller of claim 9 wherein the 3D pad comprises an x-y controller positioned on the upper surface of the housing and a z controller positioned on the second side surface.

11. The controller of claim 10 wherein the z controller comprises a first upper button and a second lower button.

12. The controller of claim 1 wherein the at least one input device further comprises a spinner wheel associated with the housing, the spinner wheel comprising a body having a relatively high moment of inertia and means for measuring both the direction of rotation and the velocity of rotation of thereof.

13. The controller of claim 12 wherein the body of the spinner wheel further includes a plurality of equally spaced openings along the outer perimeter thereof, the measuring means comprises at least one light emitter positioned on one side of the spinner wheel and at least two light detectors positioned on the opposing side of the spinner wheel.

14. A controller comprising:
a housing having an upper surface, a lower surface, opposing side surfaces and a front surface;
at least one user input device, the at least one user input device comprising spinner wheel having a relatively high moment of inertia; and
an output assembly capable of coupling the at least one user input device to an outside hardware device.

15. The controller of claim 14 wherein the spinner wheel further comprises means for measuring both the direction of rotation and the velocity of rotation of thereof.

16. The controller of claim 15 wherein the body of the spinner wheel further includes a plurality of equally spaced openings along the outer perimeter thereof, the measuring means comprises at least one light emitter positioned on one side of the spinner wheel and a dual light detector positioned on the opposing side of the spinner wheel.

17. The controller of claim 14 wherein the at least one input device further comprises at least one of the group consisting of: buttons, two position switches, three position switches and joystick.

18. The controller of claim 14 wherein the at least one input device further comprises a 3D pad associated with the housing.

19. The controller of claim 18 wherein the 3D pad comprises an x-y controller positioned on the upper surface of the housing and a z controller positioned on the second side surface.

20. The controller of claim 19 wherein the z controller comprises a first upper button and a second lower button.

21. The controller of claim 14 wherein the spinner wheel is capable of rotating through at least 3 revolutions prior to stopping.

22. The controller of claim 14 wherein the spinner wheel is capable of rotating through at least 6 revolutions prior to stopping.
